(19) United States
(12) Patent Application Publication
(10) Pub. No.: US 2017/0220616 A1
(43) Pub. Date: Aug. 3, 2017

(54) EFFICIENTLY APPLYING TIMESTAMPS TO HIGH VOLUME STREAMING DATA

(71) Applicant: INTERNATIONAL BUSINESS MACHINES CORPORATION, Armonk, NY (US)

(72) Inventor: KEVIN FREDERIC FOSTER, SAN JOSE, CA (US)

(21) Appl. No.: 15/013,774

(22) Filed: Feb. 2, 2016

(51) Int. Cl. G06F 17/30

(52) U.S. Cl. CPC G06F 17/30353; G06F 17/30516

(57) ABSTRACT

A method of timestamping may include choosing a timestamp generation frequency; receiving and caching a first timestamp from a timestamp generator;

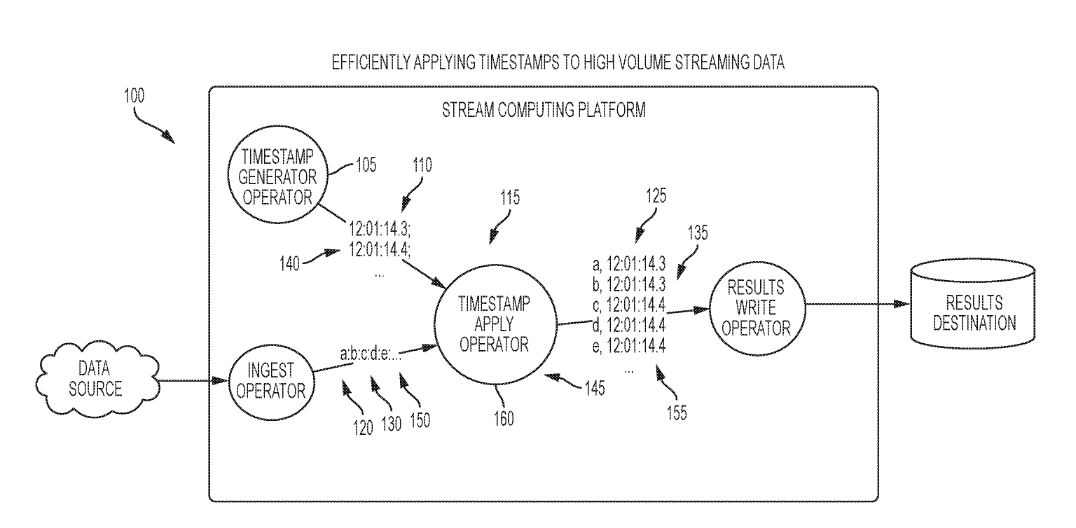

receiving a first tuple from a data input stream; attaching a cached timestamp to the first tuple from a data input stream and placing the tuple on the output queue receiving a second and third tuple from the data input stream; attaching a cached timestamp to the second and third tuples from a data input stream and placing the tuples on the output queue receiving a second timestamp from the timestamp generator; replacing the first timestamp with the second timestamp; receiving a fourth and fifth tuple from the data input stream; attaching the newer second cached timestamp to the fourth and fifth tuples from a data input stream and placing the tuples on the output queue; and repeating for newly received timestamps and tuples.

### BACKGROUND OF THE INVENTION

The present invention generally relates to applying timestamps to data. More particularly, the present invention relates to applying timestamps to high volume streaming data.

Generating timestamps for each record of data for streaming data can be expensive.

As can be seen, there is a need for a method for applying timestamps to high volume streaming data.

### SUMMARY OF THE INVENTION

In one aspect, a method may include choosing a timestamp generation frequency; receiving a first timestamp from a timestamp generator; caching the first timestamp; receiving a first tuple from a data input stream; attaching a cached timestamp to the first tuple from a data input stream and placing the tuple on the output queue; receiving a second and third tuple from the data input stream; attaching a cached timestamp to the second and third tuples from a data input stream and placing the tuples on the output queue; receiving a second timestamp from the timestamp generator; replacing the cached first timestamp with the second timestamp; receiving a fourth and fifth tuple from the data input stream; attaching the newer second cached timestamp to the fourth and five tuples from a data input stream and placing the tuples on the output queue; receiving new timestamps from the timestamp generator and receiving new tuples from the data input stream; and repeating the method for the new timestamps received from the timestamp generator and the new tuples received from the data input stream.

These and other features, aspects and advantages of the present invention will become better understood with reference to the following drawings, description and claims.

### BRIEF DESCRIPTION OF THE DRAWINGS

The Figure illustrates a method for applying timestamps to high volume streaming data.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method of applying timestamps to high volume streaming data.

In the Figure, a method 100 may include a step 105 of choosing a timestamp generation frequency. A step 110 may include receiving a first timestamp from a timestamp generator. A step 115 may include caching the first timestamp. A step 120 may include receiving a first tuple from a data input stream. A step 125 may include attaching a cached timestamp to the first tuple from a data input stream and placing the first tuple on the output queue. A step 130 may include receiving a second and third tuple from the data input. A step 135 may include attaching a cached timestamp to the second and third tuples from a data input stream and placing the tuples on the output queue. A step 140 may include receiving a second timestamp from the timestamp generator. A step 145 may include replacing the cached first timestamp with the second timestamp. A step 150 may include receiving fourth and fifth tuples from the data input stream. A step 155 may include attaching the newer second cached timestamp to the fourth and fifth tuples from a data input stream and placing the tuples on the output queue. A step 160 may include repeating the method for new timestamps and new tuples after receiving the new timestamps from the timestamp generator and receiving the new tuples from the data input stream.

In an embodiment, the method 100 may decouple system calls to get current time from the data arrival rate, and then apply a cached timestamp to streaming data at high volume..

It should be understood, of course, that the foregoing relates to exemplary embodiments of the invention and that modifications may be made without departing from the spirit and scope of the invention as set forth in the following claims.

What is claimed is:

1. A method of timestamping comprising:
choosing a timestamp generation frequency;
receiving a first timestamp from a timestamp generator;
caching the first timestamp;
receiving a first tuple from a data input stream;
attaching a cached timestamp to the first tuple from a data input stream and placing the tuple on the output queue;
receiving a second and third tuple from the data input stream;
attaching a cached timestamp to the second and third tuples from a data input stream and placing the tuples on the output queue;
receiving a second timestamp from the timestamp generator;
replacing the cached first timestamp with the second timestamp;
receiving a fourth and fifth tuple from the data input stream;
attaching the newer second cached timestamp to the fourth and fifth tuples from a data input stream and placing the tuples on the output queue; and
receiving new tuples from the timestamp generator and receiving new tuples from the data input stream;
repeating the method for new timestamps received from the timestamp generator and new tuples received from the data input stream.
